(19) United States
(12) Patent Application Publication
(10) Pub. No.: US 2022/0308488 A1
(43) Pub. Date: Sep. 29, 2022

(54) FOAMABLE TONER

(71) Applicant: HEWLETT-PACKARD DEVELOPMENT COMPANY, L.P., Spring, TX (US)

(72) Inventor: Akinori TERADA, Yokohama, Kanagawa (JP)

(21) Appl. No.: 17/765,937

(22) PCT Filed: Oct. 16, 2020
(86) PCT No.: PCT/US2020/056038

§ 371 Date: Apr. 1, 2022

(30) Foreign Application Priority Data
Oct. 29, 2019 (JP) 2019-196188

(51) Int. Cl. G03G 9/097; G03G 9/087; G03G 9/09; G03G 9/08

(52) U.S. Cl. CPC G03G 9/09775; G03G 9/08755; G03G 9/08782; G03G 9/09725; G03G 9/0918; G03G 9/081

(57) ABSTRACT

A foamable image forming toner includes a binder resin, a foaming agent, a colorant, a releasing agent and a charge control agent. An acid value of the toner is approximately 4 to 27 mgKOH/g.

### BACKGROUND

Stereoscopic printing provides viewers or consumers with three-dimensional information through shading or touch of a finger, to create visual impact and improve comprehension, and is therefore used in promotional or instruction materials. In addition, stereoscopic printing is useful for creating braille characters or braille images in maps or the like for the visually impaired.

Techniques for forming a stereoscopic image on paper include embossing in order to form projections on a paper surface, printing a highly viscous polymer ink with an ultraviolet curing property in a projected shape by using a printing technique such as silk screen and then curing it with an ultraviolet ray, printing black toner on a sheet having a thermally expandable material applied on the entire surface thereof and thermally expanding it by heating, and forming stereoscopic image with an inkjet ink containing an ultraviolet-degradable and gas-generating photosensitive compound.

### DETAILED DESCRIPTION

Some techniques for printing, copying or the like of stereoscopic prints are implemented in a large-scale system, such that stereoscopic printing is less accessible to the average consumer. In order to reduce the scale, stereoscopic images may be formed by foaming, with the use of a toner containing a foamable component that generates gas by thermal decomposition, by printing and heating. The temperature for heating should be set as low as possible. In addition, for printing braille for the visually impaired, for example, the foaming after toner fixing should be provided with a suitable image height. As a result of intensive studies, the inventor has found that stereoscopic images having a reduced foaming temperature, and suitable image height and charging property can be achieved with a foamable image forming toner which contains a binder resin, a foaming agent, a colorant, a releasing agent and a charge control agent, and which has an acid value of 4 to 27 mgKOH/g, of 6 to 27 mgKOH/g, or of 8 to 24 mgKOH/g.

An example foamable image forming toner contains a binder resin, a foaming agent, a colorant, a releasing agent and a charge control agent, in which an acid value of the toner is of 4 to 27 mgKOH/g The example foamable image forming toner may be heated at a relatively low foaming temperature to achieve a stereoscopic image having a suitable image height and a suitable charging property.

According to examples, the foamable image forming toner can be produced by using, as the binder resin, one or more selected from a polyester resin, a polyamide resin, an acrylic resin, a methacrylic resin, an epoxy-acrylic resin, an epoxy-methacrylic resin, a styrene-acrylic resin, a styrene-methacrylic resin and a urethane resin.

According to examples, the foamable image forming toner can be produced by using, as the binder resin, a polyester resin.

According to examples, the foamable image forming toner can be produced by using, as the binder resin, both a non-crystalline polyester resin and a crystalline polyester resin.

According to examples, the foamable image forming toner can be produced by setting the content of the crystalline polyester to 5 to 25 weight % relative to the weight of the foamable image forming toner.

According to examples, the foamable image forming toner can be produced by using, as the foaming agent, one or more selected from nitroso compounds, hydrazine compounds and azo compounds.

According to examples, the foamable image forming toner can be produced by using a nitroso compound as the foaming agent.

According to examples, the foamable image forming toner can be produced by setting the content of the foaming agent to 0.5 to 10 parts by weight relative to 100 parts by weight of the foamable image forming toner.

According to examples, the foamable image forming toner can be produced by using, as the releasing agent, a releasing agent containing at least ester wax.

According to examples, the foamable image forming toner can be produced by using colloidal silica as an external additive.

According to examples, the foamable image forming toner can be produced by setting a volume medium particle size D₅₀ to 3 to 15 μm.

According to examples, a foamable image forming toner having a minimum fixing temperature of 150° C. or lower can be produced.

According to examples, a foamable image forming toner can be produced by subjecting a toner raw material containing a binder resin, a foaming agent, a colorant, a releasing agent, a charge control agent and others to melt-kneading, grinding, classifying, and stirring and mixing with an external additive.

According to examples, the melt-kneading may be carried out with a biaxial kneader, a Banbury mixer or an open roll-type kneader.

According to examples, the classifying may be carried out with an air flow classifier or a centrifugal classifier.

An acid value of toner is defined by a weight of potassium hydroxide (KOH) that can neutralize 1 g of toner. According to examples, the acid value of the foamable image forming toner may be within a range selected from 4 to 27 mgKOH/g, 6 to 27 mgKOH/g, or 8 to 24 mgKOH/g, in order to achieve a sufficient or suitable image height and/or a suitable charging property. The acid value can be measured by neutralization titration method or potentiometric titration method.

According to examples, the binder resin may include resins that are selected to adjust an acid value of the toner in a simple and easy manner. Some examples of such resins include: a polyester resin and a polyimide resin both using a polycarboxylic acid as a production raw material; an acrylic resin, a methacrylic resin, an epoxy-acrylic resin, an epoxy-methacrylic resin, a styrene-acrylic resin and a styrene-methacrylic resin, all having a carboxyl group not involved in polymerization reaction; an urethane resin; and/or the like.

Among such resins polyester resins, polyacrylic resins, polymethacrylic resins, epoxy-acrylic resins, epoxy-methacrylic resins, styrene-acrylic resins and styrene-methacrylic resins and/or the like may be selected to achieve a suitable or improved toner fixing property. Examples of polyester resins will be described.

A polyester resin can be obtained by condensation polymerization of a polyol and a polycarboxylic acid. Examples of a suitable polyol include bisphenol A represented by the general formula (1), and ethylene oxide and/or propylene oxide adducts thereof; or linear-chain or branched-chain polyols with 2 to 36 carbons:

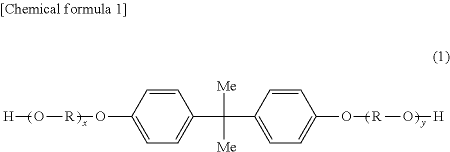

wherein Rs are the same or different and represent an ethylene group or a propylene group, x and y each represent an integer of 0 to 20, and an average of the sum of x and y is 1 to 20. Some examples of the linear-chain or branched-chain polyols with 2 to 36 carbons include: aromatic diols such as hydrogenated bisphenol A, bis(2-hydroxyethyl)terephthalate, and xylene glycol; aliphatic diols such as ethylene glycol, diethylene glycol, triethylene glycol, tetraethylene glycol, propylene glycol, dipropylene glycol, isopentyl glycol, dipropylene glycol, isopentyl glycol, 1,2-propane diol, 1,3-propane diol, 1,3-butane diol, 1,4-butane diol, 1,5-pentane diol, 1,6-hexane diol, 1,7-heptane diol, 1,8-octane diol, 1,9-nonane diol, 1,10-decane diol, 1,11-undecan diol, 1,12-dodecane diol, 1,13-tridecane diol, 1,14-tetradecane diol, 1,18-octadecane diol, 1,20-eicosane diol, 1,4-butene diol, 2,2-dimethyl-1,3-propane diol, 1,4-cyclohexane dimethanol, and 2,2,4-trimethyl-1,3-pentane diol; aliphatic triols such as glycerin, trimethylolethane and trimethylolpropane; and aliphatic tetraols such as pentaerythritol. In addition, saccharides such as sorbitol and sucrose can be used.

As the polyol, two or more selected from the above polyols may be used. Examples of the polyol that can impart a polyester resin with an improved or suitable fixing property, include bisphenol A and ethylene oxide and/or propylene oxide adducts thereof, aliphatic diols, and mixtures thereof.

In addition, a hydroxycarboxylic acid component such as p-hydroxy benzoic acid, vanillic acid, dimethylol propionic acid, malic acid, tartaric acid, and 5-hydroxyisophthalic acid may be added.

Examples of the polycarboxylic acid usable for synthesis of a polyester resin, include polyaromatic carboxylic acids and polyaliphatic carboxylic acids with 2 to 50 carbons. Examples of the polyaromatic carboxylic acids include: divalent aromatic carboxylic acids such as phthalic acid, isophthalic acid, terephthalic acid, tert-butylisophthalic acid, naphthalene-2,6-dicarboxylic acid, and 4,4′-biphenyl dicarboxylic acid; trivalent aromatic carboxylic acids such as trimesic acid, trimellitic acid, and hemimellitic acid; tetravalent aromatic carboxylic acids such as pyromellitic acid, mellophanic acid, prehnitic acid, naphthalene-1,4,5,8-tetracarboxylic acid, naphthalene-2,3,6,7-tetracarboxylic acid, biphenyl-3,3′,4,4′-tetracarboxylic acid, perylene-3,4,9,10-tetracarboxylic acid; pentavalent aromatic carboxylic acids such as benzene-pentacarboxylic acid; and hexavalent aromatic carboxylic acids such as mellitic acid.

Examples of the polyaliphatic carboxylic acids include: divalent aliphatic carboxylic acids such as oxalic acid, malonic acid, maleic acid, fumaric acid, citraconic acid, itaconic acid, glutaconic acid, succinic acid, glutaric acid, adipic acid, sebacic acid, azelaic acid, isooctenyl succinate, decyl succinate, dodecyl succinate, dodecenyl succinate, pentadecenyl succinate, octadenyl succinate, cyclohexane-1,4-dicarboxylic acid, dodecanedicarboxylic acid, octadecanedicarboxylic acid, and dimer acid; trivalent aliphatic carboxylic acids such as propane-1,2,3-tricarboxylic acid, aconitic acid, butane-1,2,4-tricarboxylic acid, hexane-1,3,6-tricarboxylic acid, cyclohexane-1,3,5-tricarboxylic acid, and adamantane-1,3,5-tricarboxylic acid; tetravalent aliphatic carboxylic acids such as ethylenetetracarboxylic acid, butane-1,2,3,4-tetracarboxylic acid, butane-1,1,3,4-tetracarboxylic acid, cyclobutane-1,2,3,4-tetracarboxylic acid, cyclopentane-1,2,3,4-tetracarboxylic acid, octahydropentalene-1,3,4,6-tetracarboxylic acid, cyclohexane-1,2,4,5-tetracarboxylic acid, and bicyclo[2.2.2]octa-7-en-2,3,5,6-tetracarboxylic acid; and hexavalent aliphatic carboxylic acids such as cyclohexane-1,2,3,4,5,6-hexacarboxylic acid.

Such polycarboxylic acids can be used in the form of: an anhydride; an ester (alkyl with 1 to 8 carbons); a diimide obtained by reaction with 4,4-diaminophenylmethane, etc.; and an isocyanate ring-containing polyimide obtained by reaction with a trimerizing reactant, etc. of tris-(J-carboxyethyl)isocyanurate, isocyanurate ring-containing polyimide, tolylene diisocyanate, xylene diisocyanate or isophorone diisocyanate.

Examples of the polycarboxylic acid that can impart a polyester resin with an improved or suitable fixing property, include isophthalic acid, terephthalic acid, trimellitic acid and pyromellitic acid as the polyaromatic carboxylic acids; and sebacic acid, azelaic acid and dodecanoic diacid as the polyaliphatic carboxylic acids. According to examples, two or more selected from such polycarboxylic acids may be used.

In addition, a hydroxycarboxylic acid component such as p-oxy benzoic acid, vanillic acid, dimethylol propionic acid, malic acid, tartaric acid, and 5-hydroxyisophthalic acid may be added to such polycarboxylic acids. In addition, such polycarboxylic acids may contain a monovalent carboxylic acid or a monovalent alcohol may be contained in order to achieve an improved or suitable molecular weight adjustment of the resin and/or the anti-offset property of the toner.

Two or more of such polyester resins may be combined, or additional resins may be combined with such polyester resins. Examples of the additional resins include styrene resins, acrylic resins, methacrylic resins, epoxy-acrylic resins, epoxy-methacrylic resins, styrene-acrylic resins, styrene-methacrylic resins, silicone resins, epoxy resins, diene resins, phenol resins, terpene resins, coumalin resins, amide resins, amide-imide resins, butyral resins, urethane resins, and ethylene-polyvinyl acetate resins.

In some examples, the binder resin may contain both of a non-crystalline polyester resin and a crystalline polyester resin. The crystalline polyester resin has a melting point, and the viscosity of the crystalline polyester resin tends to decrease rapidly at a temperature corresponding to the melting point or higher. Consequently, use of a crystalline polyester resin with a low melting point contributes to a decrease of viscosity of the toner overall. When toner is reduced in viscosity at a low temperature, it can be kneaded at a much lower temperature than the foaming temperature of a foaming agent described below.

According to examples, the polyol forming the crystalline polyester may include polyols of linear chain having a suitable crystallinity. Examples of such polyols include ethylene glycol, 1,3-propane diol, 1,4-butane diol, 1,5-pentane diol, 1,6-hexane diol, 1,7-heptane diol, 1,8-octane diol, 1,9-nonane diol, 1,10-decane diol, 1,11-undecan diol, 1,12-dodecane diol, 1,13-tridecane diol, 1,14-tetradecane diol, 1,18-octadecane diol, and 1,20-eicosane diol. According to examples, the polyol includes one or more polyol selected from the group consisting of: ethylene glycol, 1,3-propane diol, 1,4-butane diol, 1,6-hexane diol, 1,9-nonane diol, 1,10-decane diol, and 1,12-dodecane diol. In some examples, one kind of such polyol may be used, or in other examples, two or more kinds thereof may be used in combination.

The polycarboxylic acids may include an alkane dicarboxylic acid and an alkene dicarboxylic acid to provide improved or suitable crystallinity, low-temperature fixing property and heat-resistant storage stability. Some examples thereof include adipic acid, sebacic acid, azelaic acid, dodecanedicarboxylic acid, octadecanedicarboxylic acid, maleic acid and fumaric acid. In some examples, one kind of the polycarboxylic acid component may be used, or in other examples, two or more kinds thereof may be used in combination.

The crystalline polyester may have a melting point within a temperature range of 50° C. to 120° C. According to some examples, the melting point may be within a temperature range of 60° C. to 100° C. in order to reduce viscosity and improve heat-resistant storage property of the toner.

The content of the crystalline polyester in toner may range from 5 to 25%. In some examples, the crystalline polyester ranges from 6 to 20% in order to reduce viscosity and improve heat-resistant storage property of the toner.

In some examples, the above polyester resin may include a polyester resin that has been modified in such a degree that does not substantially damage its characteristics. Examples of such modified polyester resin, include polyesters grafted or blocked with phenol, urethane, epoxy or the like, or composite resins having two or more kinds of resin units including a polyester unit.

A polyester resin can be produced by causing a polyol and a polycarboxylic acid described above to react with each other in the presence of, for example, inert gas at 180° C. to 250° C. At that time, in some cases, a compound containing a metal such as tin, germanium, antimony, titanium, zinc, aluminum, and rare-earth metals; an acid such as phosphoric acid and sulfonic acid; and an organic base such as amine and amide may be used as an esterification catalyst.

A feeding ratio between the polyol and the polycarboxylic acid for the production of the polyester resin is not particularly limited. In some examples, a resulting polyester resin may be further caused to react with a polycarboxylic acid, such as the above-described polycarboxylic acid, and the reaction can be caused under conditions similar to the above-described synthesis conditions.

In order to achieve a binder resin having an a suitable kneading property under a low-temperature condition at the time of toner production, the melting point of the binder resin may be within a range of 40° C. to 150° C., 50° C. to 120° C., or 60° C. to 100° C. In addition, in order to achieve a binder resin that has suitable or improved fixing property and bubble retention by foaming, the weight average molecular weight (hereinafter, abbreviated as Mw) of the binder resin may be within a range of 3,000 to 30,000, 4,000 to 25,000, or 5,000 to 20,000. Additionally, in order to achieve a binder resin having a suitable grindability and storage stability, the glass transition point (hereinafter, abbreviated as Tg) of the binder resin may be within a range of 30° C. to 100° C., 40° C. to 80° C., or 50° C. to 70° C. Additionally, in order to achieve a binder resin that has suitable fixing property and bubble retention by foaming, the resin softening point (hereafter, abbreviated as Tm) of the binder resin may be within a range of 70° C. to 150° C., 85° C. to 125° C., or 90° C. to 110° C. When two or more kinds of resins are used, the weighted average values of the melting points, the molecular weights and the glass transition points of two or more kinds of resins may be within the above ranges.

According to examples, the foaming agent of the foamable image forming toner may include: nitroso compounds such as N,N′-dinitrosopentamethylenetetramine; azo compounds such as azodicarbon amide, barium azodicarboxylate, azobisisobutyronitrile and diazoaminobenzene; and hydrazine compounds such as 4,4′-oxybis(benzenesulfonyl hydrazide) and hydrazodicarbonamide. According to examples, two or more kinds selected from such foaming agents may be used.

According to examples, the foaming agent may be nitroso compounds in order to reduce a foaming temperature by acid. In addition, the foaming agents may be used in combination with a foaming aid such as a urea-based foaming aid.

In order to achieve a foaming agent that can achieve a sufficient or suitable image height, the content of the foaming agent to toner, may be within a range of 0.5 to 10 parts by weight, 1 to 10 parts by weight, or 1 to 8 parts by weight, relative to 100 parts by weight of toner.

Examples of additives that can be kneaded with the binder resin and the foaming agent in the foamable image forming toner include additives such as a colorant, a releasing agent, a charge control agent, magnetic powder, a fluidity improver, an electric conductivity adjustor, an extender pigment, a reinforcing filler such as a fibrous substance, an antioxidant, an anti-aging agent and a cleaning property improver.

According to examples, the colorant of the foamable image forming toner may include dyes, pigments and/or the like used as a colorant for toner. Examples of such colorant include carbon black, cyan, Phthalocyanine Blue, Permanent Brown FG, Brilliant Fast Scarlet, Pigment Green B, Rhodamine-B Base, Solvent Red 49, Solvent Red 146, Solvent Blue 35, quinacridone, carmine 6B, isoindoline, disazoyellow, Pigment Red, Pigment Yellow, Pigment Blue, lamp black, rose bengal, nigrosine dyes, metal complex dyes, derivatives of metal complex dyes and mixtures thereof. Additional examples of colorant include various metal oxides such as silica, aluminum oxide, magnate or various ferrites, cupric oxide, nickel oxide, zinc oxide, zirconium oxide, titanium oxide and magnesium oxide; and appropriate mixtures thereof. The content of such colorants may depend on the toner particle size or the amount to be developed of toner. In some examples, the amounts are within a range of 0.2 to 30 parts by weight, 1 to 20 parts by weight or 2 to 10 parts by weight, relative to 100 parts by weight of toner.

According to examples, the foamable image forming toner may contain a releasing agent. A toner containing a releasing agent can prevent an offset phenomenon or the like at the time of, for example, contact-fixing. A usable releasing agent is not particularly limited, and the following materials having releasability are usable. Examples of the releasing agent include low molecular weight polyethylenes, low molecular weight polypropylenes, and waxes including: plant-based waxes such as caranuba wax, cotton wax and Japan wax and rice wax; animal-based waxes such as beeswax and lanolin; mineral-based waxes such as ozokerite and ceresin; and petroleum waxes such as paraffin, microcrystalline and petrolatum. In addition to such natural waxes, additional waxes may be used, including: synthesized hydrocarbon waxes such as Fischer-Tropsch wax and polyethylene wax; fatty acid amides such as 12-hydroxystearic acid amide, amide stearate, imide phthalic anhydride and chlorinated hydrocarbons; and synthetic waxes such as ester waxes, ketone waxes and ether waxes. Examples of the low molecular weight crystalline polymer resin include polyacrylate homopolymers or copolymers such as polystearyl methacrylate and polylauryl methacrylate. In order to achieve a releasing agent having an improved or suitable releasability, such synthetic waxes may be used, including for example ester waxes. According to examples, the content of the releasing agent may be within a range of 0.2 to 30 parts by weight, 1 to 20 parts by weight, or 2 to 15 parts by weight, relative to 100 parts by weight of toner.

According to examples, the charge control agent of the foamable image forming toner may include any of positively chargeable charge control agents and negatively chargeable charge control agents. Examples of the positively chargeable charge control agent include: nigrosine dyes such as “Nigrosine Base EX,” “Oil Black BS,” “Oil Black SO,” “BONTRON N-01,” “BONTRON N-04,” “BONTRON N-07,” “BONTRON N-09,” and “BONTRON N-11” (hereinabove manufactured by Orient Chemical Industries Co., Ltd.); triphenylmethane-based dyes containing a tertiary amine as a side chain; quaternary ammonium salt compounds such as “BONTRON P-51” (manufactured by Orient Chemical Industries Co., Ltd.), and cetyltrimethylammonium bromide, “COPY CHARGE PX VP435” (manufactured by Clariant Ltd.); polyamine resins such as “AFP-B” (manufactured by Orient Chemical Industries Co., Ltd.); imidazole derivatives such as “PLZ-2001” and “PLZ-8001” (hereinabove, manufactured by Shikoku Chemicals Corporation); and styrene-acrylic resins such as “FCA-701PT” (manufactured by Fujikura Kase Co., Ltd.).

Examples of the negatively chargeable charge control agent include: metal-containing azo dyes such as “VARIFAST BLACK 3804,” “BONTRON S-31,” “BONTRON S-32,” “BONTRON S-34” and “BONTRON S-36” (hereinabove, manufactured by Orient Chemical Industries Co., Ltd.), and “AIZEN SPILON BLACK TRH” and “T-77” (manufactured by Hodogaya Chemical Co., Ltd.); metal compounds of benzilic acid compound such as “LR-147” and “LR-297” (hereinabove, manufactured by Japan Carlit Co., Ltd.); metal compounds of salicylic acid compound such as “BONTRON E-81,” “BONTRON E-84,” “BONTRON E-88” and “BONTRON E-304” (hereinabove, manufactured by Orient Chemical Industries Co., Ltd.), and “TN-105” (manufactured by Hodogaya Chemical Co., Ltd.); copper phthalocyanine dyes; quaternary ammonium salts such as “COPY CHARGE NX VP434” (manufactured by Clariant Ltd.) and nitroimidazole derivatives; and organometallic compounds.

In addition, a cleaning aid may be used in combination with the charge control agent. Examples of the cleaning aid include a metal soap, an inorganic metal salt or organic metal salt. The metal soap may include aluminum tristearate, aluminum distearate, stearates of barium, calcium, lead and zinc, linoleates of cobalt, manganese, lead and zinc, octoates of aluminum, calcium and cobalt, oleates of calcium and cobalt, zinc palmitate, naphthenates of calcium, cobalt, manganese, lead and zinc, and resinates of calcium, cobalt, manganese, lead and zinc. The inorganic or organic metal salt may be a salt comprising a cationic component in the metal salt selected from the group consisting of metals of Ia, IIa and IIIa groups of the period system; and an anionic component of an acid thereof selected from the group consisting of halide ions, carbonate ions, acetate ions, sulfate ions, borate ions, nitrate ions and phosphate ions. Such charge control agent and cleaning aid may be added in an amount within a range of 0.01 to 20 parts by weight, 0.1 to 5 parts by weight, or 0.5 to 2.5 parts by weight, relative to 100 parts by weight of toner, to produce an improved or targeted effect.

According to examples, the foamable image forming toner may contain a magnetic substance to impart magnetization to the toner. Examples of the magnetic substance include: metals such as iron, cobalt and nickel and alloys thereof; metallic oxides such as Fe₃O₄, γ-Fe₂O₃ and cobalt-added iron oxide; and those formed of various ferrites such as MnZn ferrite and NiZn ferrite. According to examples the magnetic substance may include Fe₃O₄ of 0.05 to 0.5 μm. Such magnetic substances may be used after treatment with various treatment agents such that they have hydrophobicity. In some examples, a plurality of the magnetic substances may be used in combination. When the toner is used as magnetic toner, the magnetic substances may be added in an amount within a range of 20 to 200 parts by weight, 40 to 150 parts by weight, or 50 to 100 parts by weight, relative to 100 parts by weight of toner.

According to examples, a foamable image forming toner can be produced by subjecting a toner raw material containing a binder resin, a foaming agent, a colorant, a releasing agent, a charge control agent and/or the like, to melt-kneading, grinding, classifying, and stirring and mixing with an external additive.

An example method for melt-kneading raw materials may be carried out by use of a biaxial kneader, a Banbury mixer, an open roll-type kneader, or the like. After being cooled, the kneaded material obtained may be subject to coarse grinding by use of a Feather Mill, a hammer mill or the like.

The resulting kneaded material or coarsely ground material can be further processed to a finely ground material with a suitable particle diameter by use of a mill. The mill may be an air flow mill or a mechanical mill, for example.

The resulting finely ground material can be classified by use of a classifier so as to achieve a narrower particle size distribution of the material. The classifier may be an air flow classifier or a centrifugal classifier, for example.

In order to achieve a particle size of the finely-ground material that provides improved or suitable image quality, the particle sizes of D₅₀ may be within a range of 3 to 15 μm, 4 to 12 μm, or 5 to 10 μm, according to examples.

In order to control the charging property or the fluidity, the classified toner may be stirred and mixed with inorganic fine particles, organic fine particles or metallic salts as an external additive. Examples of the external additive include: organic fine particles of colloidal silica, titanium oxide, alumina, cerium oxide strontium titanate or the like, and their fine particles hydrophobized as needed; organic fine particles of poly(methyl methacrylate) resin, melamine-formaldehyde resin or the like; and metallic salts such as zinc stearate. According to examples, in order to achieve an external additive having improved or suitable fluidity, the external additive may be colloidal silica. The amount of the external additive to be added may be within a range of 0.1 to 8 parts by weight, 0.2 to 4 parts by weight, or 0.4 to 2 parts by weight, relative to 100 parts by weight of the foamable image forming toner.

An example method of forming a stereoscopic image using the foamable image forming toner described, enables printing, copying or the like of stereoscopic printing by simple processes, to create, for example, braille characters, maps and the like, for the visually impaired in a simple and low-cost manner that is suitable for modern-day infrastructures of offices.

### EXAMPLES

Some examples will be described.

Production examples of example binder resins will be described. Using a flow tester (for example, “CFT-500D” manufactured by Shimadzu Corporation), 1 g of a measurement sample was extruded through a nozzle having a diameter of 1 mm and a length of 1 mm during heating of the sample at a temperature rise rate of 6° C./min and a load of 1.96 MPa was applied thereto by a plunger. Subsequently, “a downward movement (flow value) of the plunger” and “temperature” were plotted on a graph, and a resin softening point (Tm) was determined as a temperature value that is associated with half of the maximum of the downward movement of the plunger in the graph (e.g, temperature at which a half of the measurement sample has flowed out).

### Resin Production Example 1

A reaction tank includes a cooling tube, a stirrer and a nitrogen introduction tube. A reaction tank having the same shape and size was used in each of the following production examples. 350 parts of bisphenol A propylene oxide 2-mol adduct (hereinafter, referred to as BP-2P), 350 parts of bisphenol A ethylene oxide 2-mol adduct (hereinafter, referred to as BPE-20), 150 parts of terephthalic acid (hereinafter, referred to as TPA), 140 parts of isophthalic acid (hereinafter, referred to as IPA) and 3 parts of dibutyltin oxide as a condensation catalyst were introduced into the reaction tank and caused to react with one another for 5 hours in the presence of a nitrogen stream at 230° C. while produced water was distilled off, and subsequently, a reaction was caused for 3 hours under a reduced pressure of 0.5 to 2.5 kPa. Subsequently, 50 parts of trimellitic anhydride (hereinafter, referred to as TMA) and 10 parts of pyromellitic dianhydride (hereinafter, referred to as “PMDA”) were added at 210° C. to cause a reaction for 2 hours under ordinary pressure, and the resulting resin was taken out. The resin obtained was cooled to room temperature and then, ground into particles. The resulting product was used as a polyester resin (Amo1). Amo1 had a glass transition temperature (hereinafter, referred to as Tg) of 57° C., a weight average molecular weight (hereinafter, referred to as Mw) of 10,000, and a resin softening point (hereinafter, referred to as Tm) of 105° C.

### Resin Production Example 2

450 parts of BP-2P, 300 parts of BPE-20, 130 parts of TPA, 150 parts of IPA and 3 parts of dibutyltin oxide as a condensation catalyst were introduced into a reaction tank and caused to react with one another for 5 hours in the presence of a nitrogen stream at 230° C. while water produced was distilled off, and then a reaction was caused for 3 hours under a reduced pressure of 0.5 to 2.5 kPa. Subsequently, 40 parts of TMA was added at 180° C. to cause a reaction for 1 hour under ordinary pressure, and the resulting resin was taken out. The resin obtained was cooled to room temperature and then, ground into particles. The resulting product was used as a polyester resin (Amo2). Amo2 had a Tg of 60° C., a Mw of 6,000 and a Tm of 92° C.

### Resin Production Example 3

250 parts of BP-2P, 30 parts of BPE-20, 100 parts of TPA, 20 parts of IPA and 3 parts of dibutyltin oxide as a condensation catalyst were introduced into a reaction tank and caused to with one another for 5 hours in the presence of a nitrogen stream at 230° C. while water produced was distilled off, and then a reaction was caused for 3 hours under a reduced pressure of 0.5 to 2.5 kPa. Subsequently, 17 parts of TMA was added at 210° C. to cause a reaction for 1 hour under ordinary pressure; a reaction was caused under a reduced pressure of 0.5 to 5 kPa until Tm reached 110° C.; and the resulting resin was taken out. The resin obtained was cooled to room temperature and then, ground into particles. The resulting product was used as a polyester resin (Amo3). Amo3 had a Tg of 62° C., a Mw of 18,000 and a Tm of 110° C.

### Resin Production Example 4

380 parts of BP-2P, 320 parts of BPE-20, 150 parts of TPA, 140 parts of IPA and 3 parts of dibutyltin oxide as a condensation catalyst were introduced into a reaction tank and caused to react with one another for 5 hours in the presence of a nitrogen stream at 230° C. while water produced was distilled off. Then, a reaction was caused for 5 hours under a reduced pressure of 0.5 to 2.5 kPa, and the resulting resin was taken out. The resin obtained was cooled to room temperature and then, ground into particles. The resulting product was used as a polyester resin (Amo4). Amo4 had a Tg of 57° C., a Mw of 9,000 and a Tm of 105° C.

### Resin Production Example 5

450 parts of BP-2P, 300 parts of BPE-20, 130 parts of TPA, 150 parts of IPA and 3 parts of dibutyltin oxide as a condensation catalyst were introduced into a reaction tank and caused to react with one another for 5 hours in the presence of a nitrogen stream at 230° C. while water produced was distilled off. Then, a reaction was caused for 5 hours under a reduced pressure of 0.5 to 2.5 kPa, and the resulting resin was taken out. The resin obtained was cooled to room temperature and then, ground into particles. The resulting product was used as a polyester resin (Amo5). Amo5 had a Tg of 59° C., a Mw of 5,800 and a Tm of 91° C.

### Resin Production Example 6

250 parts of BP-2P, 30 parts of BPE-20, 100 parts of TPA, 20 parts of IPA and 3 parts of dibutyltin oxide as a condensation catalyst were introduced into a reaction tank and caused to react with one another for 5 hours in the presence of a nitrogen stream at 230° C. while water produced was distilled off, and then, a reaction was caused for 3 hours under a reduced pressure of 0.5 to 2.5 kPa. Subsequently, 8 parts of TMA was added at 210° C. to cause a reaction for 1 hour under ordinary pressure; a reaction was caused under a reduced pressure of 0.5 to 5 kPa until Tm reached 110° C.; and the resulting resin was taken out. The resin obtained was cooled to room temperature and then, ground into particles. The resulting product was used as a polyester resin (Amo6). Amo6 had a Tg of 62° C., a Mw of 18,000 and a Tm of 109° C.

### Resin Production Example 7

350 parts of BP-2P, 350 parts of BPE-20, 150 parts of TPA, 140 parts of IPA and 3 parts of dibutyltin oxide as a condensation catalyst were introduced into a reaction tank and caused to react with one another for 5 hours in the presence of a nitrogen stream at 230° C. while water produced was distilled off, and then, a reaction was caused for 3 hours under a reduced pressure of 0.5 to 2.5 kPa. Subsequently, 60 parts of TMA and 13 parts of pyromellitic dianhydride (hereinafter, referred to as “PMDA”) were added at 210° C. to cause a reaction for 2 hours under ordinary pressure, and the resulting resin was taken out. The resin obtained was cooled to room temperature and then, ground into particles. The resulting product was used as a polyester resin (Amo7). Amo7 had a Tg of 57° C., a Mw of 10,500 and a Tm of 105° C.

### Resin Production Example 8

189 parts of 1,9-nonane diol, 261 parts of 1,12-dodecanoic diacid and 2 parts of dibutyltin oxide as a condensation catalyst were introduced into a reaction tank and heated to 180° C. to cause a reaction for 8 hours in the presence of a nitrogen stream at 180° C. while water produced was distilled off. Subsequently, a reaction was caused for 3 hours by gradually heating to 220° C. in the presence of a nitrogen stream while water was distilled off. In addition, a reaction was caused under a reduced pressure of 0.007 to 0.026 MPa while water was distilled off, so that a crystalline polyester resin (Cry1) was obtained.

### Resin Production Example 9

158 parts of 1,6-hexane diol, 246 parts of sebacic acid and 2 parts of dibutyltin oxide as a condensation catalyst were introduced into a reaction tank and heated to 180° C. to cause a reaction for 8 hours in the presence of a nitrogen stream at 180° C. while water produced was distilled off. Subsequently, a reaction was caused for 3 hours by gradually heating to 220° C. in the presence of a nitrogen stream while water produced was distilled off. In addition, a reaction was caused under a reduced pressure of 0.007 to 0.026 MPa while water was distilled off, so that a crystalline polyester resin (Cry2) was obtained.

For Resin Production Examples 1 to 9, feeding amounts of polyols, polycarboxylic acids and condensation catalysts expressed in parts by weight, and their Tgs, Mws and Tms are summarized in Tables 1A and 1B.

An example method for producing a foamable image forming toner composition containing a binder resin produced in each of Resin Production Examples 1 to 9 will be described.

The polyester resins Amo1 to Amo7, Cry1 and Cry2 obtained with the Resin Production Examples 1 to 9, respectively, were premixed with a foaming agent (N,N′-dinitrosopentamethylenetetramine, DPT-based foaming agent Cellmic A manufactured by Sankyo Kasei Co., Ltd.), a cyan pigment (PB15:3 (C.I.15:3)), an ester wax (WE-15 manufactured by NOF Corporation) and a charge control agent (TN-105 manufactured by Hodogaya Chemical Co., Ltd.) at weight ratios indicated in Tables 2A and 2B. For the premixing, a Henschel mixer (FM10B manufactured by Nippon Coke & Engineering Company, Limited) was used. Subsequently, melt-kneading was carried out by using a biaxial kneader (PCM-30 manufactured by Kabushiki Kaisha Ikegai) at a cylinder setting temperature of 105±5° C., a shaft rotation speed of 200 rpm, and a feeding amount of 5 kg/h, and then the mixture was cooled down to room temperature. The mixture obtained was finely ground by use of a supersonic jet mill LABO Jet (manufactured by Nippon Pneumatic Mfg. Co., Ltd.); and classified by an airflow classifier (MDS-I manufactured by Nippon Pneumatic Mfg. Co., Ltd.), so that toner particles having a volume medium particle size D₅₀ of 8 μm were obtained. Subsequently, 0.5 parts of colloidal silica (Aerosil R972 manufactured by Nippon Aerosil Co., Ltd., average particle diameter of 16 nm) was mixed with 100 parts of toner particles in a sample mill, so as to obtain foamable stereoscopic image forming toners T-1 to T-6 (associated with Production Examples 1 to 6, respectively), and foamable stereoscopic image forming toners RT-1 and RT-2 (associated with Comparative Production Examples 1 and 2, respectively). The acid values of the produced toner compositions were measured by a neutralization titration method prescribed in JIS K 0070-1992.

### Example 1

An example method of development and fixing onto a substrate using each of the produced foamable image forming toners, and each of the methods for evaluating a printed image after fixing are described, taking T-1 as an example.

The foamable image forming toner (T-1) was developed on a test paper sheet of 60 g (X-9 manufactured by Boise) by a cake printing method such that a deposition amount of toner per unit area (hereinafter, referred to as TAM) was 0.84 mg/cm². Cake printing is a developing method in which a potential difference between a mesh and paper is created and toner is dusted on the paper through the mesh, to develop the toner on the paper by electrostatic force. The amount of toner developed can be determined by measuring a weight increase of the paper. The unfixed image obtained was fixed at a fixing speed of 10 mm/sec. by use of a belt-type fixing device (fixing device of a color laser 660 model manufactured by Samsung Electronics Co., Ltd.). The fixing was performed at temperatures varying at 5° C. intervals, in the range of 120° C. to 160° C. The minimum fixing temperature (MFT) was the lowest temperature at which no cold offset occurred. An image height was set to an average value of heights determined at 5 locations of a solid image measured by Surfcom 920A (manufactured by Tokyo Seimitsu Co., Ltd.) at that temperature. The non-foaming fixing thickness was a value calculated on the assumption that a toner layer does not cause foaming, and was calculated with the following equation.

Non-foaming fixing thickness=[TAM/1.2]×10 (μm)

Regarding measurement of a non-foaming fixing thickness (μm) charging amount, a preliminary preparation was first performed, by which 28.5 g of magnetic substance carrier (SY129 manufactured by KDK) and 1.5 g of toner were introduced in a 60 mL-glass container to form a mixture which was left to stand for 12 hours in an environment at a temperature of 50° C. and a relative humidity of 80% for a charging amount HH and in an environment with a temperature of 10° C. and a relative humidity of 10% for a charging amount LL. Subsequently, the mixture was stirred for 10 minutes by use of a Turbula mixer. The charging amounts of the toner for respective environments were measured by an electrolytic separation method. The charging amounts obtained were used as the charging amount HH and the charging amount LL, respectively. The environmental dependency of charging amounts was calculated by dividing the charging amount HH by the charging amount LL.

Unfixed images of TAM shown in Tables 3A and 2B were created in the same manner as in Example 1 and then, MFTs and image heights were measured. In addition, the charging amounts and the environmental dependencies were measured by the same method as in Example 1.

As shown in Tables 3A and 3B, all of Examples 1 to 8 and Comparative Examples 1 and 2 had a minimum fixing temperature within a range of 130° C. to 140° C., which were significantly decreased from the foaming temperature of DPT of 200° C. to 210° C.

In addition, Examples 1 to 8 having a toner acid value of 8 to 24 mgKOH/g and Comparative Example 2 having a toner acid value of 28 mgKOH/g had an image height after fixing of 31 to 101 μm, and exhibited suitable values for image height ratios of 4.9 to 13.0 calculated by (image height after fixing)/(non-foaming fixing thickness). In Comparative Example 1 having an acid value of 3 mgKOH/g, the image height after fixing was 5 μm and the image height ratio was 0.7, both of which were lower than the above.

Meanwhile, regarding the charging amount HH, Examples 1 to 8 and Comparative Example 1 exhibited 50 to 58 μC/g while Comparative Example 2 having a toner acid value of 28 mgKOH/g exhibited as low as 28 μC/g. Regarding the charging amount LL, all of Examples and Comparative Examples exhibited 62 to 73 μC/g. Comparative Example 2 having a higher acid value exhibited a lower charging amount environmental dependency which was of 0.45, and this confirmed that a charging amount was significantly dependent on an environmental temperature or humidity.

Accordingly, the Examples demonstrated that a toner acid value lower than 4 mgKOH/g cannot provide a sufficient image height, and a toner acid value higher than 27 mgKOH/g deteriorates the charging property, for example in a high humidity environment.

TABLE 1A

| | | Resin Production Examples | | | | |
|---|---|---|---|---|---|---|
| | | 1 | 2 | 3 | 4 | 5 |
| Polyester Resins | | Amo1 | Amo2 | Amo3 | Amo4 | Amo5 |
| Feeding | BP-2P | 350 | 450 | 250 | 380 | 450 |
| amount | BPE-20 | 350 | 300 | 30 | 320 | 300 |
| (part by | 1,9ND | | | | | |
| weight) | 1,6HD | | | | | |
| | TPA | 150 | 130 | 100 | 150 | 130 |
| | IPA | 140 | 150 | 20 | 140 | 150 |
| | TMA | 50 | 40 | 17 | | |
| | PMDA | 10 | | | | |
| | 1,12DDA | | | | | |
| | 1,8SA | | | | | |
| | Condensation | 3 | 3 | 3 | 3 | 3 |
| | catalyst | | | | | |
| Physical | Tg | 57 | 60 | 62 | 57 | 59 |
| properties | Mw | 10000 | 6000 | 18000 | 9000 | 5800 |
| | Tm | 105 | 92 | 110 | 105 | 91 |

TABLE 1B

| | | Resin Production Examples | | | |
|---|---|---|---|---|---|
| | | 6 | 7 | 8 | 9 |
| Polyester Resins | | Amo6 | Amo7 | Cry1 | Cry2 |
| Feeding | BP-2P | 250 | 350 | | |
| amount | BPE-20 | 30 | 350 | | |
| (part by | 1,9ND | | | 189 | |
| weight) | 1,6HD | | | | 158 |
| | TPA | 100 | 150 | | |
| | IPA | 20 | 140 | | |
| | TMA | 8 | 60 | | |
| | PMDA | | 13 | | |
| | 1,12DDA | | | 261 | |
| | 1,8SA | | | | 246 |
| | Condensation | 3 | 3 | 2 | 2 |
| | catalyst | | | | |
| Physical | Tg | 61 | 57 | — | — |
| properties | Mw | 17500 | 10500 | 5600 | 5200 |
| | Tm | 109 | 105 | — | — |

The labels in Tables 1A and 1B are described as follows:
BP-2P: bisphenol A propylene oxide 2-mol adduct
BPE-20: bisphenol A ethylene oxide 2-mol adduct
1,9ND: 1,9-nonane diol
1,6H-D: 1,6-hexane diol
TPA: terephthalic acid
IPA: isophthalic acid
TMA: trimellitic anhydride
PMDA: pyromellitic dianhydride
1,12DDA: dodecanoic diacid
1,8SA: sebacic acid
Condensation catalyst: dibutyltin oxide

TABLE 2A

| | | Production Examples | | | |
|---|---|---|---|---|---|
| | | 1 | 2 | 3 | 4 |
| Toners | | T-1 | T-2 | T-3 | T-4 |
| Feeding amount | Amo1 | 40 | 40 | 41 | 0 |
| (part by weight) | Amo2 | 20 | 18 | 16.5 | 29.5 |
| | Amo3 | 15.5 | 15.5 | 14 | 28 |
| | Amo4 | | | | 11 |
| | Amo5 | | | | |
| | Amo6 | | | | |
| | Amo7 | | | | |
| | Cry1 | 10 | 10 | 10 | 15 |
| | Cry2 | | | | |
| | Cyan pigment | 4.5 | 4.5 | 4.5 | 4.5 |
| | Ester wax | 8 | 8 | 8 | 8 |
| | DPT | 2 | 4 | 6 | 4 |
| | Charge control agent | 1 | 1 | 1 | 1 |
| | Total | 101 | 101 | 101 | 101 |
| | Acid value | 17 | 17 | 17 | 8 |

TABLE 2B

| | | | | Comparative | |
|---|---|---|---|---|---|
| | | Production | | Production | |
| | | Examples | | Examples | |
| | | 5 | 6 | 1 | 2 |
| Toners | | T-5 | T-6 | RT-1 | RT-2 |
| Feeding amount | Amo1 | 76 | 40 | | |
| (part by weight) | Amo2 | 0 | 18 | | |
| | Amo3 | 0 | 15.5 | | |
| | Amo4 | | | 40 | |
| | Amo5 | | | 18 | |
| | Amo6 | | | 15.5 | |
| | Amo7 | | | | 75.5 |
| | Cry1 | 7.5 | | 10 | 8 |
| | Cry2 | | 10 | | |
| | Cyan pigment | 4.5 | 4.5 | 4.5 | 4.5 |
| | Ester wax | 8 | 8 | 8 | 8 |
| | DPT | 4 | 4 | 4 | 4 |
| | Charge control agent | 1 | 1 | 1 | 1 |
| | Total | 101 | 101 | 101 | 101 |
| | Acid value | 24 | 17 | 3 | 28 |

In Tables 2A and 2B, DPT represents N,N′-dinitrosopentamethylenetetramine.

TABLE 3A

| | Examples | | | | |
|---|---|---|---|---|---|
| | 1 | 2 | 3 | 4 | 5 |
| Toner in use | T1 | T2 | T3 | T2 | T2 |
| Deposition amount of | 0.84 | 0.84 | 0.84 | 0.42 | 1.26 |
| toner (mg/cm2) | | | | | |
| Minimum fixing temp. | 140 | 140 | 140 | 140 | 140 |
| (MFT) | | | | | |
| Fixing temp. | 140 | 140 | 140 | 140 | 140 |
| Non-foaming fixing | 7 | 7 | 7 | 3.5 | 10.5 |
| thickness (μm) | | | | | |
| Image height after fixing | 34 | 65 | 97 | 31 | 101 |
| (μm) | | | | | |
| Image height ratio | 4.9 | 9.3 | 13.9 | 8.9 | 9.6 |
| Charging amount HH | 50 | 53 | 51 | 53 | 53 |
| (μC/g) | | | | | |
| Charging amount LL | 73 | 70 | 73 | 70 | 70 |
| (μC/g) | | | | | |
| Environmental | 0.68 | 0.76 | 0.70 | 0.76 | 0.76 |
| dependency of charging | | | | | |
| amounts (HH/LL) | | | | | |

TABLE 3B

| | | | | Comparative | |
|---|---|---|---|---|---|
| | Examples | | | Examples | |
| | 6 | 7 | 8 | 1 | 2 |
| Toner in use | T4 | T5 | T6 | TC1 | TC2 |
| Deposition amount of | 0.84 | 0.84 | 0.84 | 0.84 | 0.84 |
| toner (mg/cm2) | | | | | |
| Minimum fixing temp. | 130 | 130 | 130 | 140 | 140 |
| (MFT) | | | | | |
| Fixing temp. | 140 | 130 | 130 | 140 | 140 |
| Non-foaming fixing | 7 | 7 | 7 | 7 | 7 |
| thickness (μm) | | | | | |
| Image height after fixing | 66 | 64 | 64 | 5 | 68 |
| (μm) | | | | | |
| Image height ratio | 9.4 | 9.1 | 9.1 | 0.7 | 9.7 |
| Charging amount HH | 50 | 55 | 50 | 58 | 28 |
| (μC/g) | | | | | |
| Charging amount LL | 70 | 74 | 67 | 73 | 62 |
| (μC/g) | | | | | |
| Environmental | 0.71 | 0.74 | 0.75 | 0.79 | 0.45 |
| dependency of charging | | | | | |
| amounts (HH/LL) | | | | | |

1. A foamable image forming toner comprising:
a binder resin;
a foaming agent,
a colorant;
a releasing agent; and
a charge control agent,
wherein an acid value of the foamable image forming toner is of approximately 4 to 27 mgKOH/g.

2. The foamable image forming toner according to claim 1, wherein the binder resin includes one or more resins selected from the group consisting of: a polyester resin, a polyamide resin, an acrylic resin, a methacrylic resin, an epoxy-acrylic resin, an epoxy-methacrylic resin, a styrene-acrylic resin, a styrene-methacrylic resin and an urethane resin.

3. The foamable image forming toner according to claim 1, wherein the binder resin is a polyester resin.

4. The foamable image forming toner according to claim 1, wherein the binder resin comprises a non-crystalline polyester resin and a crystalline polyester resin.

5. The foamable image forming toner according to claim 1, wherein the content of the crystalline polyester is 5 to 25 weight % relative to the weight of the foamable image forming toner.

6. The foamable image forming toner according to claim 1, wherein the foaming agent is one or more selected from the group consisting of: nitroso compounds, hydrazine compounds and azo compounds.

7. The foamable image forming toner according to claim 6, wherein the foaming agent is a nitroso compound.

8. The foamable image forming toner according to claim 1, wherein the content of the foaming agent is of approximately 0.5 to 10 parts by weight relative to 100 parts by weight of the foamable image forming toner.

9. The foamable image forming toner according to claim 1, wherein the releasing agent comprises at least ester wax.

10. The foamable image forming toner according to claim 1, comprising colloidal silica as an external additive.

11. The foamable image forming toner according to claim 1, wherein a volume medium particle size D50 is 3 to 15 μm.

12. The foamable image forming toner according to claim 1, wherein a minimum fixing temperature is approximately 150° C. or less.

13. A method for producing a foamable image forming toner comprising a binder resin, a foaming agent, a colorant, a releasing agent, and a charge control agent, wherein an acid value of the foamable image forming toner is of approximately 4 to 27 mgKOH/g, the method comprising:
subjecting a toner raw material comprising the binder resin, the foaming agent, the colorant, the releasing agent, and the charge control agent to melt-kneading, grinding, classifying, and stirring and mixing with an external additive.

14. The method according to claim 13, wherein the melt-kneading is performed by use of a biaxial kneader, a Banbury mixer or an open roll-type kneader.

15. The method according to claim 13, wherein the classifying is performed by use of an air flow classifier or a centrifugal classifier.
